(19) United States
(12) Patent Application Publication
(10) Pub. No.: US 2024/0338407 A1
(43) Pub. Date: Oct. 10, 2024

(54) INFORMATION PROCESSING APPARATUS, METHOD, AND PROGRAM

(71) Applicant: FUJIFILM CORPORATION, Tokyo (JP)

(72) Inventor: Kenta KAWAMATA, Tokyo (JP)

(21) Appl. No.: 18/626,164

(22) Filed: Apr. 3, 2024

(30) Foreign Application Priority Data
Apr. 7, 2023 (JP) 2023-063069

(51) Int. Cl. G06F 16/58; G06F 16/538

(52) U.S. Cl. CPC G06F 16/5866; G06F 16/538

(57) ABSTRACT

A processor is configured to: extract at least one related keyword related to an image from at least one of the image or a sentence described in a first document related to the image; refer to correspondence information in which a plurality of second documents of a different type from the first document are associated with at least one keyword included in each of the second documents, and specify at least one second document associated with a keyword that matches or is similar to the related keyword; and provide a notification of the specified document.

### CROSS REFERENCE TO RELATED APPLICATIONS

The present application claims priority from Japanese Patent Application No. 2023-063069, filed on Apr. 7, 2023, the entire disclosure of which is incorporated herein by reference.

### BACKGROUND

### Technical Field

The present disclosure relates to an information processing apparatus, method, and program.

### Related Art

In recent years, advances in medical devices, such as computed tomography (CT) apparatuses and magnetic resonance imaging (MRI) apparatuses, have enabled image diagnosis using high-resolution medical images with higher quality. In particular, in a case of performing image diagnosis using CT images, MRI images, or the like, an interpretation report including an interpretation result of an image is created. Various methods have been proposed to support the creation of medical documents such as interpretation reports.

For example, JP2012-141797A discloses an invention in which report information designated from report information stored in a database is read and displayed, keywords from character information included in the read report information are extracted, and a list of related reports related to the extracted keywords is displayed in order based on the importance of the keywords. Further, JP2015-207261A discloses an invention in which, in a case in which a specific character string included in an interpretation report is a registered keyword, a registered keyword is associated with an interpretation report so that it can be searched as the interpretation report including the registered keyword, and in a case in which a registered keyword is included in a character string input by a user at the time of searching for an interpretation report, a list of corresponding interpretation reports is displayed. Further, JP2015-162082A discloses an invention in which a character string related to a predetermined item for specifying a medical image is extracted from examination information or findings information input in an interpretation report and a related medical image related to the extracted character string is specified from among a plurality of medical images.

However, in the case of creating a sentence describing results of interpreting a medical image, such as an interpretation report, rather than past interpretation reports, reference is often made to a document of a different type from the interpretation report, such as a paper or guideline.

### SUMMARY OF THE INVENTION

The present disclosure has been made in view of the above circumstances, and an object of the present disclosure is to allow easy reference to a document of a different type from a document in which a sentence to be created is described in the case of creating a sentence related to an image.

According to an aspect of the present disclosure, there is provided an information processing apparatus comprising: at least one processor, in which the processor is configured to: extract at least one related keyword related to an image from at least one of the image or a sentence described in a first document related to the image; refer to correspondence information in which a plurality of second documents of a different type from the first document are associated with at least one keyword included in each of the second documents, and specify at least one second document associated with a keyword that matches or is similar to the related keyword; and provide a notification of the specified document.

In the information processing apparatus according to the aspect of the present disclosure, the processor may be configured to: extract the related keyword from both the image and the sentence described in the first document; and specify, in a case in which a related keyword common to the image and the sentence described in the first document is extracted, the second document associated with a keyword that matches or is similar to the common related keyword.

In the information processing apparatus according to the aspect of the present disclosure, the processor may be configured to: extract the related keyword from both the image and the sentence described in the first document; and provide, in a case in which a related keyword common to the image and the sentence described in the first document is extracted, a notification of the second document associated with a keyword that matches or is similar to the common related keyword with priority over the second document associated with a keyword that matches or is similar to a related keyword other than the common related keyword.

In the information processing apparatus according to the aspect of the present disclosure, the processor may be configured to preferentially provide a notification of the second document associated with a keyword that has a high relevance to the related keyword.

In the information processing apparatus according to the aspect of the present disclosure, the keywords may be classified for each of properties of the keywords.

In the information processing apparatus according to the aspect of the present disclosure, the processor may be configured to: extract a keyword from the second document; and derive the correspondence information by associating the extracted keyword with the second document.

In the information processing apparatus according to the aspect of the present disclosure, the processor may be configured to provide a notification of the specified document by displaying a list of the specified second documents.

In the information processing apparatus according to the aspect of the present disclosure, the processor may be configured to display the list such that at least a part of the list overlaps a region in which the first document is displayed.

According to another aspect of the present disclosure, there is provided an information processing method executed by a computer, the information processing method comprising: extracting at least one related keyword related to an image from at least one of the image or a sentence described in a first document related to the image; referring to correspondence information in which a plurality of second documents of a different type from the first document are associated with at least one keyword included in each of the second documents, and specifying at least one second document associated with a keyword that matches or is similar to the related keyword; and providing a notification of the specified document.

According to another aspect of the present disclosure, there is provided an information processing program causing a computer to execute: extracting at least one related keyword related to an image from at least one of the image or a sentence described in a first document related to the image; referring to correspondence information in which a plurality of second documents of a different type from the first document are associated with at least one keyword included in each of the second documents, and specifying at least one second document associated with a keyword that matches or is similar to the related keyword; and providing a notification of the specified document.

According to the aspects of the present disclosure, it is possible to easily refer to a document of a different type from a document in which a sentence to be created is described in the case of creating a sentence from an image.

### BRIEF DESCRIPTION OF THE DRAWINGS

FIG. 1 is a diagram showing an example of a schematic configuration of a medical information system to which an information processing apparatus according to a first embodiment is applied.

FIG. 2 is a block diagram showing a hardware configuration of the information processing apparatus according to the first embodiment.

FIG. 3 is a block diagram showing a functional configuration of the information processing apparatus according to the first embodiment.

FIGS. 4A and 4B show diagrams for describing generation of correspondence information.

FIG. 5 is a diagram showing correspondence information.

FIG. 6 is a diagram showing a creation screen of an interpretation report.

FIG. 7 is a diagram showing related keywords extracted from a comment on findings.

FIG. 8 is a diagram showing the creation screen of the interpretation report in which a notification of a specified document is provided.

FIG. 9 is a diagram showing the creation screen of the interpretation report in which corresponding reference documents are displayed.

FIG. 10 is a flowchart showing a process performed in the first embodiment.

FIG. 11 is a block diagram showing a functional configuration of an information processing apparatus according to a second embodiment.

FIG. 12 is a flowchart showing a process performed in the second embodiment.

FIG. 13 is a diagram showing another example of displaying a list of the corresponding reference documents.

FIG. 14 is a diagram showing another example of displaying the list of the corresponding reference documents.

FIG. 15 is a diagram showing another example of displaying the list of the corresponding reference documents.

FIG. 16 is a diagram showing another example of displaying the list of the corresponding reference documents.

### DETAILED DESCRIPTION

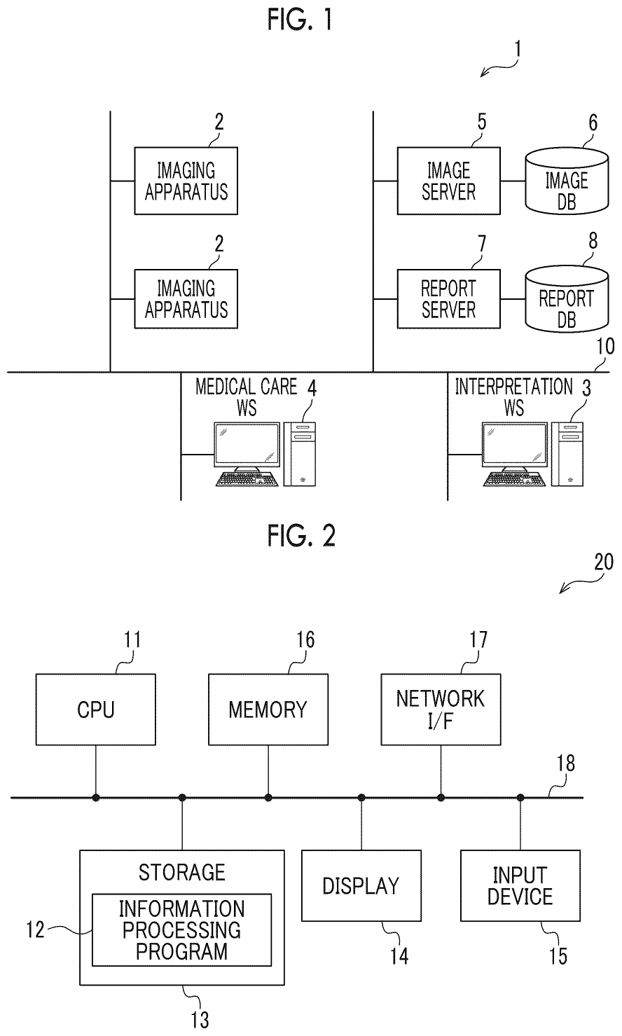

Hereinafter, embodiments of the present disclosure will be described with reference to the drawings. First, a configuration of a medical information system 1 to which an information processing apparatus according to a first embodiment is applied will be described. FIG. 1 is a diagram showing a schematic configuration of the medical information system 1. The medical information system 1 shown in FIG. 1 is, based on an examination order from a doctor in a medical department using a known ordering system, a system for imaging an examination target part of a subject, storing a medical image acquired by the imaging, interpreting the medical image by a radiologist and creating an interpretation report, and viewing the interpretation report and observing the medical image to be interpreted in detail by the doctor in the medical department that is a request source.

As shown in FIG. 1, in the medical information system 1, a plurality of imaging apparatuses 2, a plurality of interpretation workstations (WSs) 3 that are interpretation terminals, a medical care WS 4, an image server 5, an image database (hereinafter referred to as an image DB) 6, a report server 7, and a report database (hereinafter referred to as a report DB) 8 are communicably connected to each other through a wired or wireless network 10.

Each apparatus is a computer on which an application program for causing each apparatus to function as a component of the medical information system 1 is installed. The application program is stored in a storage apparatus of a server computer connected to the network 10 or in a network storage in a state in which it can be accessed from the outside, and is downloaded to and installed on the computer in response to a request. Alternatively, the application program is recorded on a recording medium, such as a digital versatile disc (DVD) and a compact disc read-only memory (CD-ROM), and distributed, and is installed on the computer from the recording medium.

The imaging apparatus 2 is an apparatus (modality) that generates a medical image showing a diagnosis target part of the subject by imaging the diagnosis target part. Specifically, examples of the imaging apparatus include a simple X-ray imaging apparatus, a CT apparatus, an MRI apparatus, a positron emission tomography (PET) apparatus, and the like. The medical image generated by the imaging apparatus 2 is transmitted to the image server 5 and is stored in the image DB 6.

The interpretation WS 3 is a computer used by, for example, a radiologist of a radiology department to interpret a medical image and to create an interpretation report, and encompasses an information processing apparatus 20 according to the first embodiment. In the interpretation WS 3, a viewing request for a medical image to the image server 5, various image processing for the medical image received from the image server 5, display of the medical image, input reception of comments on findings regarding the medical image, and the like are performed. In the interpretation WS 3, creation of an interpretation report, a registration request and a viewing request for the interpretation report to the report server 7, display of the interpretation report received from the report server 7, and the like are performed. The above processes are performed by the interpretation WS 3 executing software programs for respective processes. The medical care WS 4 is a computer used by a doctor in a medical department to observe an image in detail, view an interpretation report, create an electronic medical record, and the like, and is configured to include a processing apparatus, a display apparatus such as a display, and an input apparatus such as a keyboard and a mouse. In the medical care WS 4, a viewing request for the image to the image server 5, display of the image received from the image server 5, a viewing request for the interpretation report to the report server 7, and display of the interpretation report received from the report server 7 are performed. The above processes are performed by the medical care WS 4 executing software programs for respective processes.

The image server 5 is a general-purpose computer on which a software program that provides a function of a database management system (DBMS) is installed. The image server 5 comprises a storage in which the image DB 6 is configured. The storage may be a hard disk apparatus connected to the image server 5 by a data bus, or may be a disk apparatus connected to a storage area network (SAN) or a network attached storage (NAS) connected to the network 10. In a case in which the image server 5 receives a request to register a medical image from the imaging apparatus 2, the image server 5 prepares the medical image in a format for a database and registers the medical image in the image DB 6.

Image data of the medical image acquired by the imaging apparatus 2 and accessory information are registered in the image DB 6. The accessory information includes, for example, an image identification (ID) for identifying each medical image, a patient ID for identifying a subject, an examination ID for identifying an examination, a unique ID (unique identification (UID)) allocated for each medical image, examination date and examination time at which a medical image is generated, the type of imaging apparatus used in an examination for acquiring a medical image, patient information such as the name, age, and gender of a patient, an examination part (an imaging part), imaging information (an imaging protocol, an imaging sequence, an imaging method, imaging conditions, the use of a contrast medium, and the like), and information such as a series number or a collection number in a case in which a plurality of medical images are acquired in one examination.

In addition, in a case in which the viewing request from the interpretation WS 3 and the medical care WS 4 is received through the network 10, the image server 5 searches for a medical image registered in the image DB 6 and transmits the searched for medical image to the interpretation WS 3 and to the medical care WS 4 that are request sources.

The report server 7 incorporates a software program for providing a function of a database management system to a general-purpose computer. In a case in which the report server 7 receives a request to register the interpretation report from the interpretation WS 3, the report server 7 prepares the interpretation report in a format for a database and registers the interpretation report in the report DB 8.

In the report DB 8, an interpretation report created by the radiologist using the interpretation WS 3 is registered. The interpretation report may include information such as, for example, a medical image to be interpreted, an image ID for identifying the medical image, a radiologist ID for identifying the radiologist who performed the interpretation, a disease name, disease position information, and information for accessing a medical image.

Further, in a case in which the report server 7 receives the viewing request for the interpretation report from the interpretation WS 3 and the medical care WS 4 through the network 10, the report server 7 searches for the interpretation report registered in the report DB 8, and transmits the searched for interpretation report to the interpretation WS 3 and to the medical care WS 4 that are request sources.

The network 10 is a wired or wireless local area network that connects various apparatuses in a hospital to each other. In a case in which the interpretation WS 3 is installed in another hospital or clinic, the network 10 may be configured to connect local area networks of respective hospitals through the Internet or a dedicated line.

Next, the information processing apparatus 20 according to the first embodiment encompassed in the interpretation WS 3 will be described. First, with reference to FIG. 2, a hardware configuration of the information processing apparatus 20 according to the first embodiment will be described. As shown in FIG. 2, the information processing apparatus 20 includes a central processing unit (CPU) 11, a non-volatile storage 13, and a memory 16 as a temporary storage area. Further, the information processing apparatus 20 includes a display 14 such as a liquid crystal display, an input device 15 consisting of a pointing device such as a keyboard and a mouse, and a network interface (I/F) 17 connected to the network 10. The CPU 11, the storage 13, the display 14, the input device 15, the memory 16, and the network I/F 17 are connected to a bus 18. The CPU 11 is an example of a processor in the present disclosure.

The storage 13 is realized by a hard disk drive (HDD), a solid-state drive (SSD), a flash memory, and the like. An information processing program 12 is stored in the storage 13 as the storage medium. The CPU 11 reads out the information processing program 12 from the storage 13, loads the information processing program 12 into the memory 16, and executes the loaded information processing program 12.

Further, in the present embodiment, the storage 13 stores a reference document referred to in a case of creating an interpretation report. The reference document is a document of a different type from the interpretation report, such as a guideline for diagnosis and a medical paper. The interpretation report is an example of a first document of the present disclosure, and the reference document is an example of a second document.

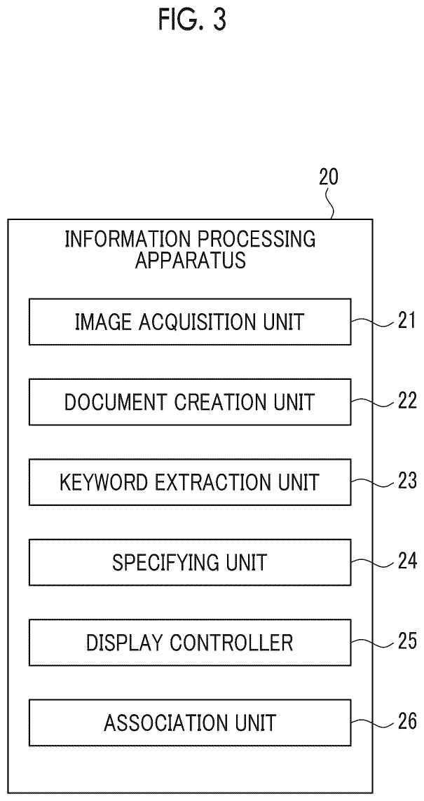

Next, a functional configuration of the information processing apparatus according to the first embodiment will be described. FIG. 3 is a diagram showing a functional configuration of the information processing apparatus according to the first embodiment. As shown in FIG. 3, the information processing apparatus 20 comprises an image acquisition unit 21, a document creation unit 22, a keyword extraction unit 23, a specifying unit 24, a display controller 25, and an association unit 26. Then, in a case in which the CPU 11 executes the information processing program 12, the CPU 11 functions as the image acquisition unit 21, the document creation unit 22, the keyword extraction unit 23, the specifying unit 24, the display controller 25, and the association unit 26.

In the first embodiment, the storage 13 stores a plurality of reference documents of different types from the interpretation report, such as various guidelines for image diagnosis and medical papers. In the first embodiment, correspondence information in which the reference documents and at least one keyword included in each of the reference documents are associated with each other is stored in the storage 13. The correspondence information may be created by each user such as a radiologist, but the correspondence information may be created in a unit of a hospital so that the doctor in the hospital uses common correspondence information.

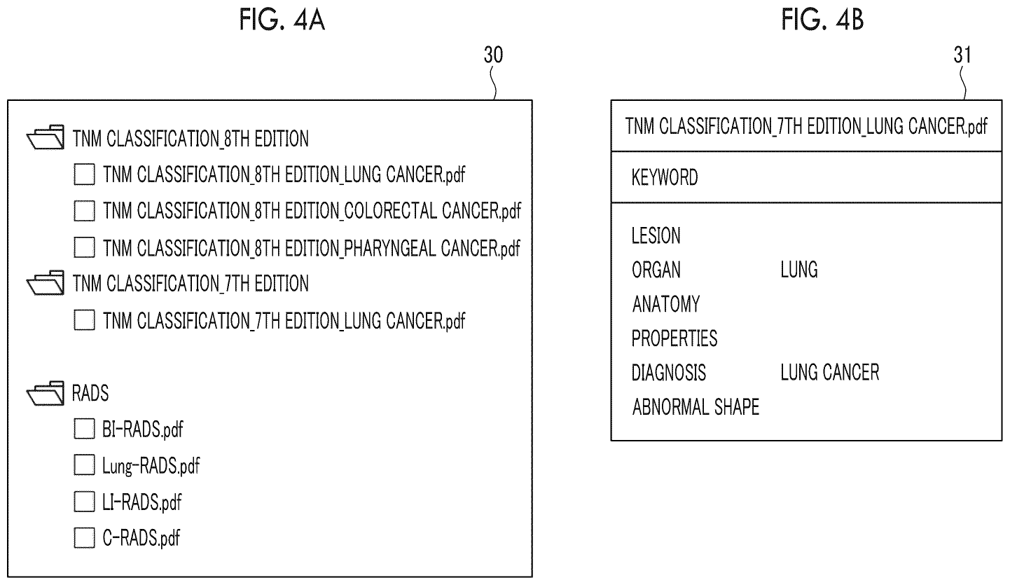

In the first embodiment, the correspondence information is derived by the association unit 26. First, the derivation of the correspondence information by the association unit 26 will be described. FIGS. 4A and 4B show diagrams for describing derivation of correspondence information. In a case in which the user gives an instruction to derive correspondence information from the input device 15, the association unit 26 displays a list of reference documents stored in the storage 13 on the display 14 as shown in FIG. 4A. As shown in FIG. 4A, a list 30 of reference documents includes, for example, folders for a “TNM classification_8th edition”, a “TNM classification_7th edition”, and a “RADS”, and it is shown that reference documents consisting of PDF files are stored in each folder.

Note that TNM classification is a method of classifying a cancer according to how advanced the cancer is (in terms of the stage), in order to use it as a guideline in a case of treatment. In the TNM classification, “T” indicates the spread (depth of invasion or the like) of the primary cancer, “N” indicates the presence or absence of metastasis of cancer cells to the lymph node and its spread, and “M” indicates distant metastasis to organs distant from the primary cancer. RADS is an abbreviation for reporting and data system and is a diagnostic algorithm for hepatocellular carcinoma proposed by American college of radiology. In addition, LI-RADS is an abbreviation for liver imaging reporting and data system, BI-RADS is an abbreviation for breast imaging reporting and data system, and C-RADS is an abbreviation for CT colonography reporting and data system.

In a case in which the user selects a desired reference document from the list 30 of reference documents using the input device 15, the association unit 26 extracts keywords for the selected reference document from the file name of the reference document and the text within the reference document. Keywords can be extracted using, for example, a file name of the reference document, a name of an organ included in the reference document, a disease name, a property of a lesion, a shape of the lesion, an anatomical region where the lesion occurs, and the like, but are not limited thereto. Then, the association unit 26 displays a list of keywords related to the reference document selected by the user on the display 14 as shown in FIG. 4B. A list 31 of keywords shown in FIG. 4B is classified into a lesion, an organ, anatomy, properties, a diagnosis, and an abnormal shape for each property of keywords. In the list 31 shown in FIG. 4B, it is shown that “lung” is extracted as a keyword for the organ, and “lung cancer” is extracted as a keyword for the diagnosis.

Note that the user can add or delete keywords from the list 31 of keywords as necessary. Then, in a case in which the user performs an operation of storing the keyword from the input device 15, the association unit 26 generates correspondence information C0 by associating the extracted keyword with the reference information selected by the user, and stores the generated correspondence information C0 in the storage 13.

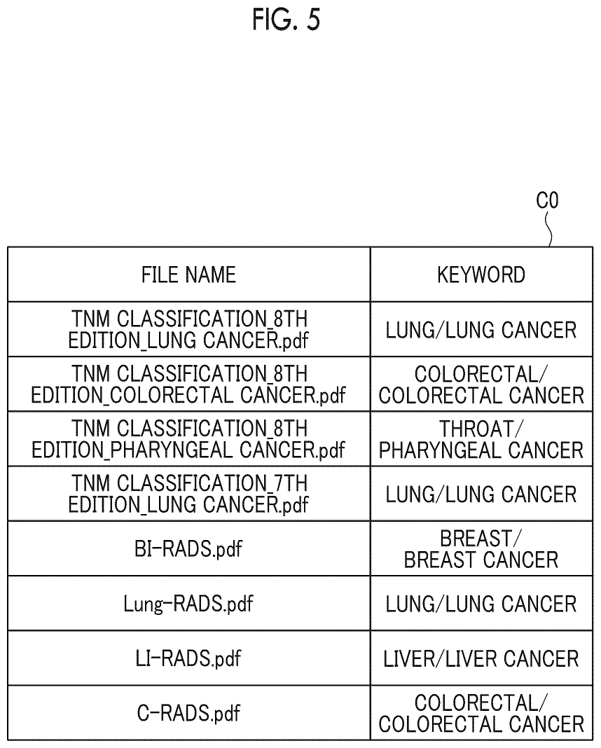

FIG. 5 is a diagram showing correspondence information C0. As shown in FIG. 5, in the correspondence information C0, the file name of the reference document stored in the storage 13 and at least one keyword are associated with each other. Note that the correspondence information C0 may be derived by the user manually associating the reference document with the keyword.

The image acquisition unit 21 acquires a medical image to be interpreted for creating an interpretation report from the image server 5 according to an instruction from the input device 15 by the user. A medical image to be interpreted is referred to as a target medical image G0 in the following description.

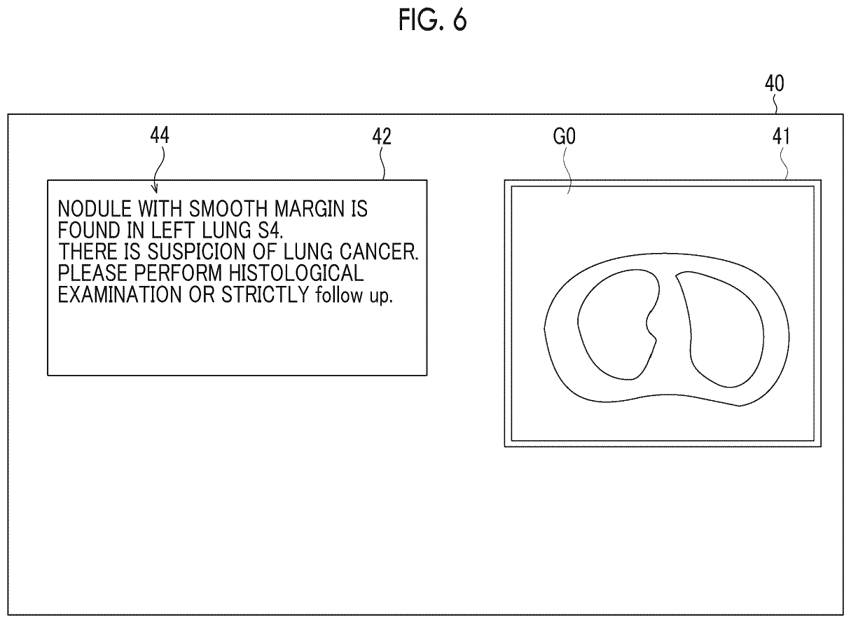

The document creation unit 22 creates an interpretation report including findings regarding the target medical image G0 based on input by the user from the input device 15. FIG. 6 is a diagram showing a creation screen of an interpretation report. As shown in FIG. 6, a creation screen 40 of the interpretation report includes an image region 41 for displaying the target medical image G0 and a document region 42 for inputting a comment on findings. The user inputs the comment on findings to the document region 42 using the input device 15. For example, in FIG. 6, a comment on findings 44 “A nodule with a smooth margin is found in left lung S4. There is a suspicion of lung cancer. Please perform a histological examination or strictly follow up” is input. The comment on findings 44 is an example of a sentence of the present disclosure.

In the comment on findings 44, for example, a property of a lesion included in the target medical image G0, a shape of the lesion, a disease name, a size, an anatomical region, and the like are described. Note that not all examples thereof are described. For example, in a case in which the lesion is included in the lung, the properties are described in terms of a plurality of items such as a type of opacity (solid type and ground-glass type), the presence or absence of a nodule, the presence or absence of a spicula, the presence or absence of a calcification, the presence or absence of a cavity, the presence or absence of a pleural invagination, the presence or absence of a pleural contact, the presence or absence of a pleural infiltration, and the like.

Regarding the properties, the shape of a lesion such as a nodule, a tumor, and a calcification is described in the comment on findings 44. For example, a shape such as a smooth margin and an irregular margin is described.

Regarding the disease name, a suspected disease name is described in the comment on findings 44. For example, in a case in which the lesion is in the lung, the disease name such as lung cancer, lung adenocarcinoma, interstitial pneumonia, and the like is described.

Regarding the size, the size of the lesion is described in the comment on findings 44.

Regarding the anatomical region, an anatomical region of an organ including the lesion is described in the comment on findings 44. For example, in the case of the lung, the anatomical region can be divided into the left lung and the right lung, and the anatomical region can be divided into five lobes (upper lobe of left lung, lower lobe of left lung, upper lobe of right lung, middle lobe of right lung, and lower lobe of right lung). Furthermore, the anatomical regions of regions S1 to S8 can be divided for each of the left lung and the right lung. Furthermore, the anatomical region of the liver can be divided into regions S1 to S8 in addition to the left lobe and right lobe. Furthermore, the anatomical region of the kidney can be divided into left and right regions.

In addition, notes for diagnosis and the like are also described in the comment on findings 44. For example, in the comment on findings 44 shown in FIG. 6, “Please perform a histological examination or strictly follow up” is described as a note.

In a case in which the user gives an instruction to display the reference document from the input device 15, the keyword extraction unit 23 analyzes the comment on findings 44 to extract keywords related to the target medical image G0 included in the comment on findings 44. Specifically, the keyword extraction unit 23 extracts, from the comment on findings 44, the keyword related to the target medical image G0 included in the comment on findings 44 by analyzing the character string included in the comment on findings 44 using natural language processing technology. Hereinafter, the keywords extracted from the comment on findings will be used as related keywords.

The natural language processing is a series of technologies for causing a computer to process a natural language that humans use on a daily basis. By the natural language processing, it is possible to divide a sentence into words, analyze the syntax, analyze the meaning, and the like. The keyword extraction unit 23 uses natural language processing technology to divide the character string included in the comment on findings 44 into words, and acquires related keywords by analyzing the syntax.

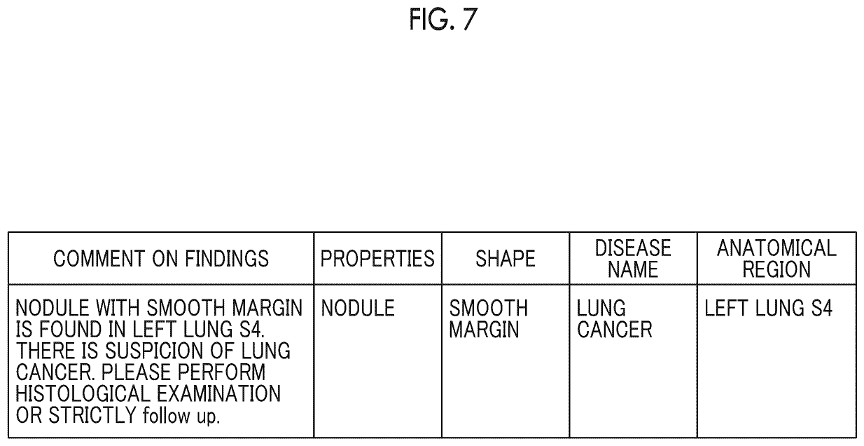

In the first embodiment, the comment on findings 44 is “A nodule with a smooth margin is found in left lung S4. There is a suspicion of lung cancer. Please perform a histological examination or strictly follow up”. The keyword extraction unit 23 extracts “left lung S4”, “smooth margin”, “nodule”, and “lung cancer” as related keywords. That is, as shown in FIG. 7, “nodule”, “smooth margin”, “lung cancer”, and “left lung S4” are extracted as the related keywords of the property, the shape, the disease name, and the anatomical region.

The specifying unit 24 refers to the correspondence information C0 and specifies a reference document associated with a keyword that matches the related keyword extracted by the keyword extraction unit 23. In the first embodiment, the related keywords are “nodule”, “smooth margin”, “lung cancer”, and “left lung S4”. Therefore, the specifying unit 24 refers to the correspondence information C0 shown in FIG. 5, and specifies three reference documents with file names of “TNM Classification_8th Edition_Lung Cancer.pdf”, “TNM Classification_7th Edition_Lung Cancer.pdf” and “Lung-RADS.pdf” that are associated with “lung” as a keyword, as corresponding reference documents that are associated with related keywords.

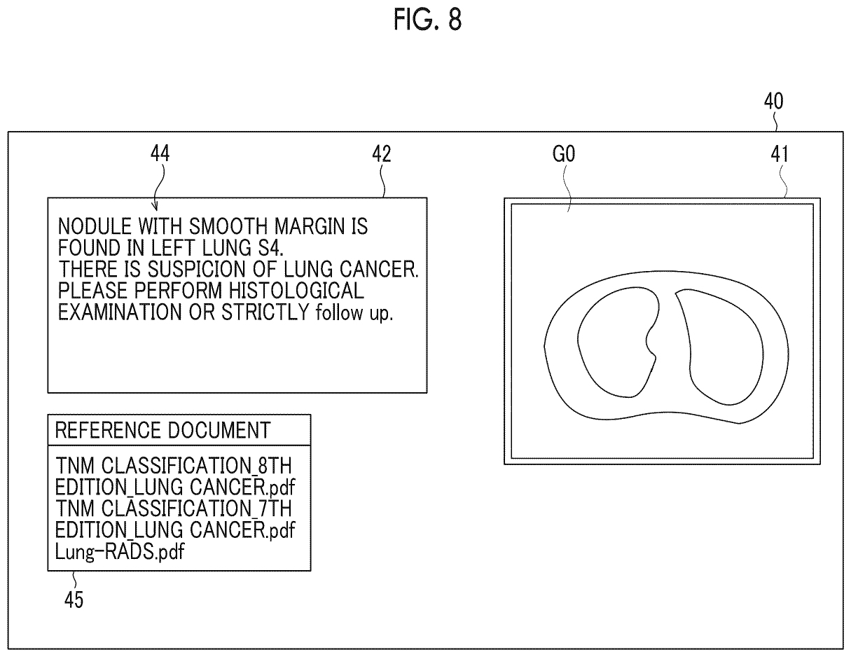

The display controller 25 provides a notification of the specified result by displaying a list of the corresponding reference documents specified by the specifying unit 24 on the display 14. FIG. 8 is a diagram showing the creation screen of the interpretation report in which a notification of the specified document is provided. As shown in FIG. 8, a window 45 including a list of the corresponding reference documents is displayed on the creation screen 40 of the interpretation report. In FIG. 8, “reference document” is simply displayed in the window 45, and a list of the file names of the corresponding reference documents is displayed.

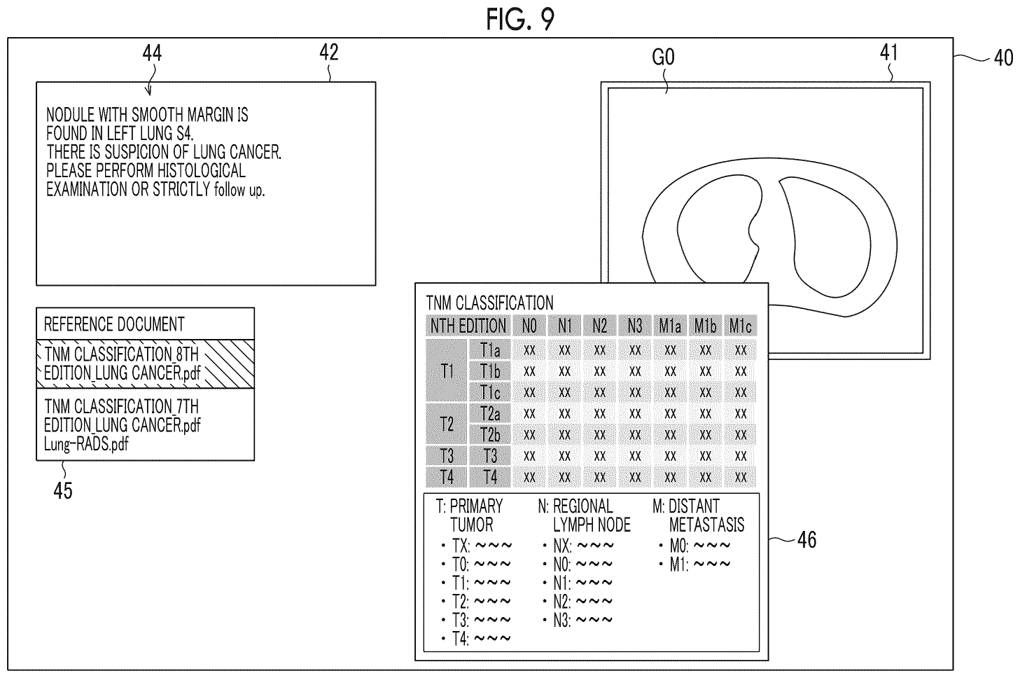

The user can use the input device 15 to select a desired reference document from the list of the corresponding reference documents displayed in the window 45. Then, as shown in FIG. 9, the selected corresponding reference document is displayed in a window 46. FIG. 9 shows a state in which “TNM Classification_8th Edition_Lung Cancer.pdf” is selected as the reference document and “TNM Classification_8th Edition_Lung Cancer.pdf” is displayed in the window 46. Therefore, the user can refer to the corresponding reference document displayed in the window 46 and continue writing the interpretation report.

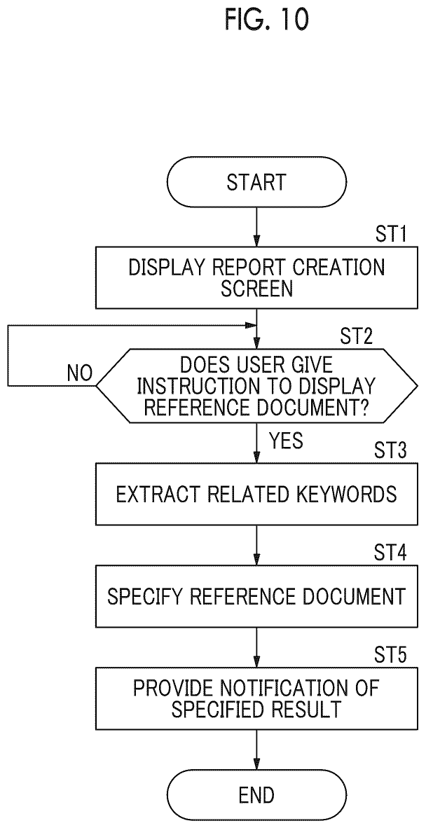

Next, a process performed in the first embodiment will be described. FIG. 10 is a flowchart showing a process performed in the first embodiment. It is assumed that the correspondence information C0 has been derived and stored in the storage 13. It is also assumed that the target medical image G0 for which an interpretation report is to be created is also stored in the storage 13. The process is started in response to a user's instruction to create an interpretation report, and the display controller 25 displays the creation screen 40 of the interpretation report on the display 14 (Step ST1).

In a case in which the user gives an instruction to display the reference document (Step ST2: affirmative), the keyword extraction unit 23 extracts related keywords from the comment on findings 44 (Step ST3), and the specifying unit 24 refers to the correspondence information C0 and specifies a reference document associated with a keyword that matches the related keyword (Step ST4). Then, the display controller 25 provides a notification of the specified result (Step ST5), and ends the process.

The user can display the desired corresponding reference document in the specified result and continue to create the interpretation report. The created interpretation report is transmitted to the report server 7 and is stored in the report DB 8.

In this way, in the first embodiment, related keywords are extracted from the input comment on findings, and a reference document of a different type from the interpretation report including the comment on findings, which is associated with a keyword that matches the related keyword, is specified, and a notification of the specified document is provided. Therefore, the user can easily refer to documents related to the document he or she is trying to create, such as an interpretation report.

Note that in the above embodiment, in a case in which the user gives an instruction to display a reference document, the related keyword is extracted and the reference document is specified, but the present disclosure is not limited thereto. During the input of the comment on findings, for example, in a case in which the conversion of the comment on findings is confirmed, the related keyword may be extracted from the comment on findings being input to specify the reference document.

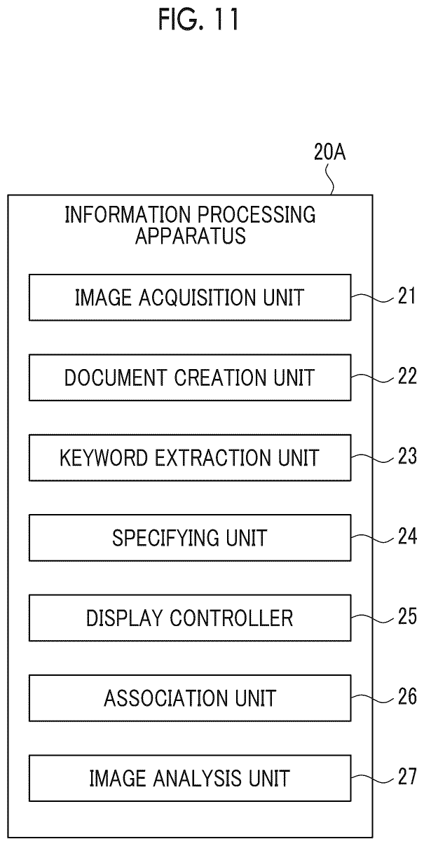

Next, a second embodiment of the present disclosure will be described. FIG. 11 is a diagram showing a functional configuration of an information processing apparatus according to a second embodiment. In FIG. 11, the same reference numerals are assigned to the same configurations as those in FIG. 3, and detailed description thereof will be omitted. In the first embodiment, the related keywords are extracted from the comments on findings input to the document region 42. However, the second embodiment differs from the first embodiment in that, in addition to the comments on findings, related keywords are also extracted from the target medical image G0 displayed in the image region 41. For this reason, an information processing apparatus 20A according to the second embodiment further comprises an image analysis unit 27.

The image analysis unit 27 derives the properties of each pixel of the medical image by analyzing the medical image. To this end, the image analysis unit 27 has a trained model (not shown) in which machine learning is performed to specify the properties of each pixel of the medical image. In the present embodiment, the trained model consists of a convolutional neural network (CNN) in which deep learning has been performed using supervised training data to discriminate which property each pixel (voxel) represents in a medical image.

The trained model is prepared for each organ, and in a case in which a medical image is input, the trained model calculates a probability that each pixel of the medical image has various properties (for example, nodule, tumor, ground-glass, cavity, normal region, and the like), and specifies the property with the highest probability as the property of that pixel. Furthermore, the image analysis unit 27 specifies an anatomical region in which the property is present, based on the property output by the trained model. Therefore, the image analysis unit 27 extracts the property specified by the trained model and the anatomical region in which the region of the specified property is present from the target medical image G0 as related keywords. For example, in a case in which a nodule is present in right lung S1 of the lung included in the target medical image G0, “right lung S1” and “nodule” are extracted from the target medical image G0 as related keywords.

In the second embodiment, the specifying unit 24 refers to the correspondence information C0 and specifies, as a corresponding reference document, a reference document in which a common keyword is associated between a related keyword (referred to as a first related keyword) extracted from the comment on findings by the keyword extraction unit 23 and a related keyword (referred to as a second related keyword) extracted from the target medical image G0 by the image analysis unit 27. Note that the processing after specifying the corresponding reference document is the same as the processing in the first embodiment.

Here, in the second embodiment, there is a case in which the first related keyword extracted from the comment on findings and the second related keyword extracted from the target medical image G0 do not completely match. For example, in a case in which the comment on findings includes only the matters related to the lung, the first related keyword includes “lung”. On the other hand, in a case in which an abnormality is found in the liver as well as the lung as a result of analyzing the target medical image G0, the second related keywords are “lung” and “liver”. In this case, the specifying unit 24 specifies, as a corresponding reference document, a reference document in which “lung”, which is common to the first related keyword and the second related keyword, is associated as a keyword.

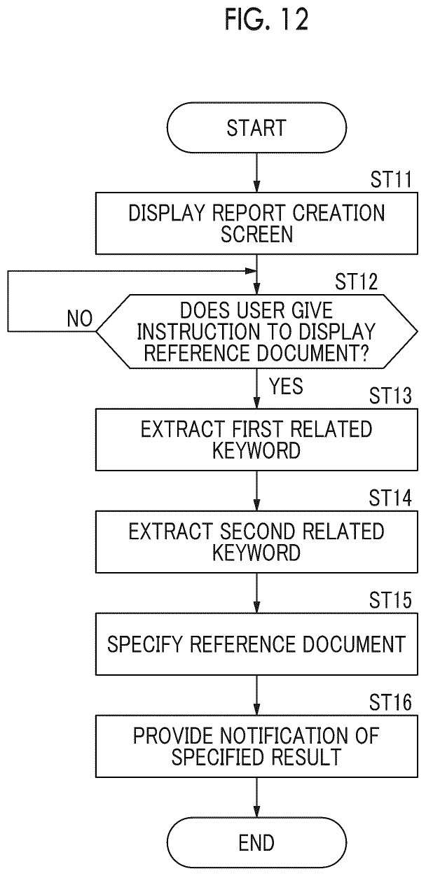

Next, a process performed in the second embodiment will be described. FIG. 12 is a flowchart showing the process performed in the second embodiment. It is assumed that the correspondence information C0 has been derived and stored in the storage 13. It is also assumed that the target medical image G0 for which an interpretation report is to be created is also stored in the storage 13. The process is started in response to a user's instruction to create an interpretation report, and the display controller 25 displays the creation screen 40 of the interpretation report on the display 14 (Step ST11).

In a case in which the user gives an instruction to display the reference document (Step ST12: affirmative), the keyword extraction unit 23 extracts a first related keyword from the comment on findings 44 (Step ST13), and the image analysis unit 27 extracts a second related keyword from the target medical image G0 by analyzing the target medical image G0 (Step ST14). Then, the specifying unit 24 refers to the correspondence information C0 and specifies, as a corresponding reference document, a reference document associated with a keyword common to the first related keyword and the second related keyword (Step ST15). Then, the display controller 25 provides a notification of the specified result (Step ST16), and ends the process.

Accordingly, in the second embodiment as well as in the first embodiment, the user can easily refer to documents related to the document he or she is trying to create.

Note that, in the second embodiment, a reference document in which all the keywords of the first related keyword and the second related keyword are associated may be specified as the corresponding reference document. In this case, in a case of notifying of the specified document, a reference document in which a keyword common to the first related keyword and the second related keyword is associated may be preferentially displayed.

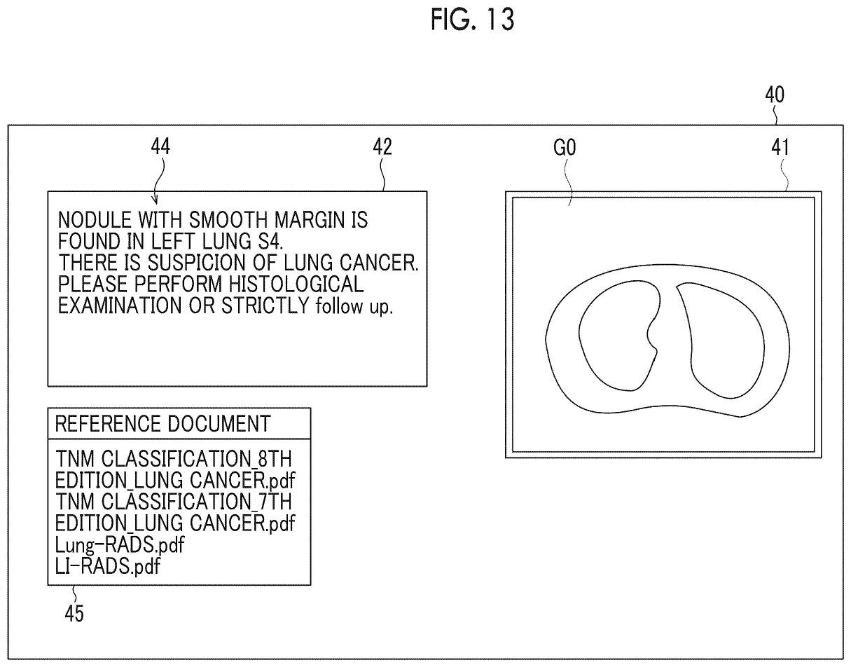

For example, as described above, in a case in which the first related keyword is “lung” and the second related keywords are “lung” and “liver”, as shown in FIG. 13, the reference documents “TNM Classification_8th Edition_Lung Cancer.pdf”, “TNM Classification_7th Edition_Lung Cancer.pdf”, and “Lung-RADS.pdf” for the common keyword “lung” may be displayed higher than the reference document “LI-RADS.pdf” for the liver.

In addition, in the first embodiment, related keywords are extracted from only the comment on findings, and in the second embodiment, related keywords are extracted from both the comment on findings and the target medical image G0, but the present disclosure is not limited thereto. Related keywords may be extracted only from the target medical image G0.

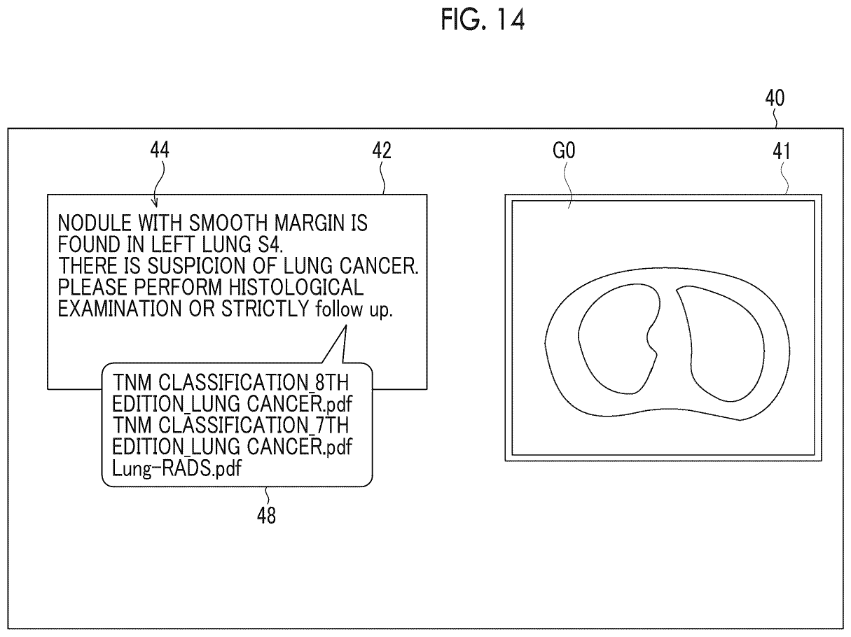

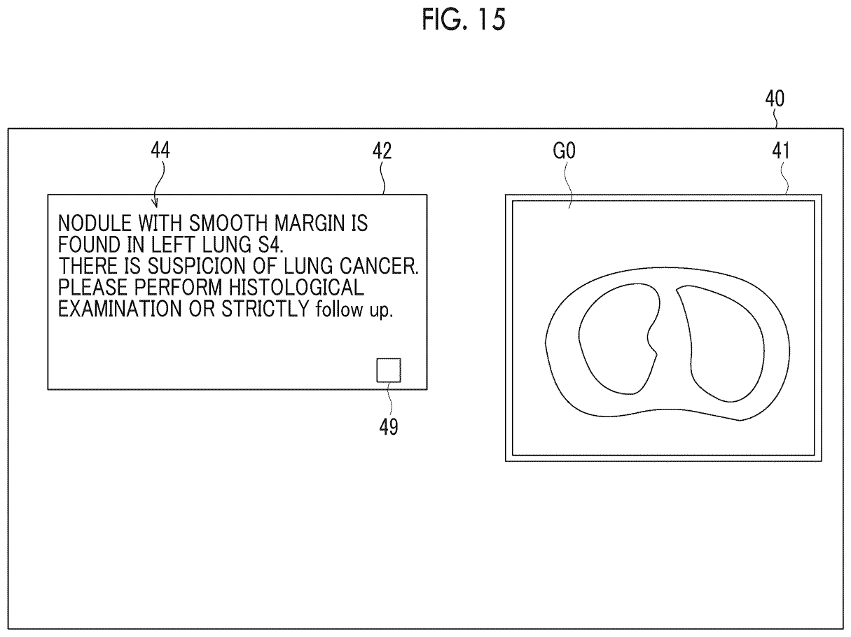

Furthermore, in each of the above embodiments, a list of the specified corresponding reference documents is displayed in the window 45, but the present disclosure is not limited thereto. As shown in FIG. 14, a notification of the specified document may be provided by displaying a pop-up 48 to overlap at least a part of the document region 42 in which the comment on findings 44 is being input, and displaying a list of the corresponding reference documents in the pop-up 48. Moreover, as shown in FIG. 15, a notification of the presence of a corresponding reference document may be provided through an icon 49. In this case, in a case in which the icon 49 is selected, a window 43 may be opened to display a list of reference documents, or a pop-up 48 may be displayed to display a list of reference documents.

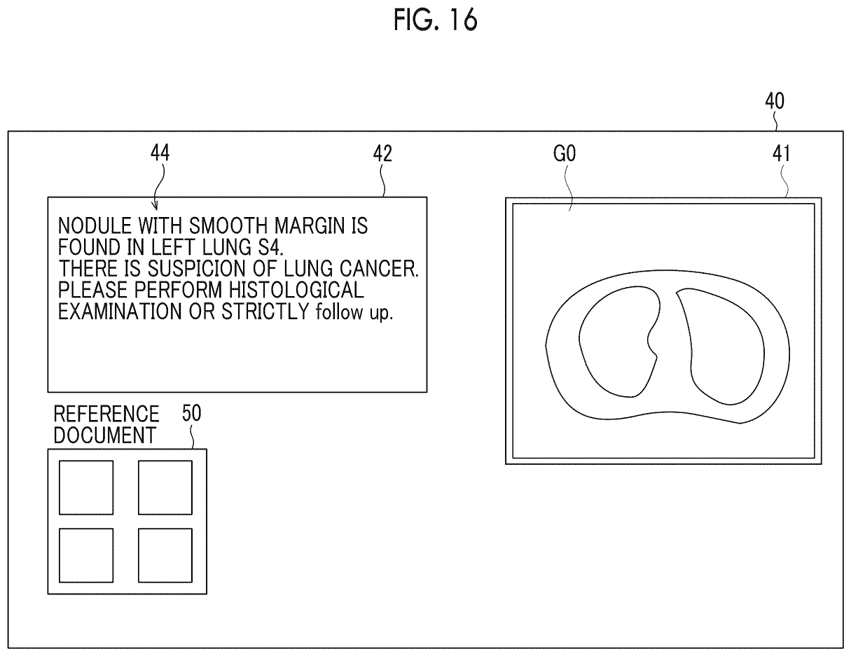

Furthermore, in each of the above embodiments, a list of the file names of the specified corresponding reference documents is displayed in the window 43, but the present disclosure is not limited thereto. As shown in FIG. 16, instead of the file name, a list 50 of thumbnail images of corresponding reference documents may be displayed.

Furthermore, in each of the embodiments described above, in a case in which the association unit 26 extracts keywords from the reference document, the keywords may be extracted in more detail. For example, in the above embodiment, “lung” is extracted as the keyword, but anatomical region of the lungs such as right lung S1 and left lung S4 may be extracted as keywords. Thereby, in a case in which the anatomical region of the lungs is described in the comment on findings 44, by extracting the anatomical region of the lungs as a related keyword, a reference document corresponding to the anatomical region of the lungs can be specified. Therefore, the user can create an interpretation report by referring to a reference document more suitable for findings of the target medical image G0.

In this way, in a case in which the anatomical region of the lungs is extracted as a related keyword, a reference document in which the organ name “lung”, which is a superordinate concept of the anatomical region of the lungs, is associated as a keyword may also be specified. In this case, reference documents associated with keywords that have a high relevance to the related keywords may be displayed preferentially. For example, in a case in which the related keyword is the anatomical region, a reference document associated with an anatomical region as a keyword has a higher relevance to the related keyword than a reference document associated with an organ name as a keyword. Therefore, in the list of reference documents, it is preferable to display a reference document associated with the anatomical region higher than a reference document associated with the organ. Thereby, the user can more easily refer to the reference document related to the interpretation report being created.

Furthermore, in the above embodiment, the number of hits for keywords extracted from the reference document may be included in the correspondence information C0 in the association unit 26. In this case as well, reference documents associated with keywords that have a high relevance to the related keywords may be displayed preferentially. For example, a reference document with a larger number of hits for keywords that match the related keyword has a higher relevance to the related keyword. Therefore, in the case of notifying of the result of specifying the reference document based on the related keyword, in the list of reference documents, it is preferable to display a reference document with a large number of hits for keywords that match the related keyword higher than a reference document with a small number of hits. In this case as well, the user can create an interpretation report by referring to a reference document more suitable for findings of the target medical image G0.

Furthermore, in each of the above embodiments, the reference documents associated with keywords that match the related keyword are specified, but the present disclosure is not limited thereto. For example, in a case in which there is no reference document associated with a keyword that matches the related keyword in the correspondence information C0, a reference document associated with a keyword similar to the related keyword may be specified. For example, it is assumed that, in a case in which “tumor” is described in the comment on findings 44 and “tumor” is extracted as the related keyword, a reference document associated with “tumor” as a keyword is not included in the correspondence information C0, but a reference document associated with “nodule” as a keyword is included in the correspondence information C0. In this case, the reference document associated with “nodule” as a keyword may be specified as the corresponding reference document, and a notification of the specified result may be provided.

Further, in the above embodiment, a reference document of a PDF file is used, but the present disclosure is not limited thereto. A reference document in any file format can be used, such as a text file or an image file. Note that since the image file does not include a keyword, the association unit cannot automatically derive the correspondence information C0. Therefore, in a case in which an image file is used as a reference document, the user need only manually associate keywords with image files to derive the correspondence information C0. In addition, the association unit 26 may derive keywords by applying the trained model of the image analysis unit 27 in the second embodiment and analyzing the image file, associate the image file with the keywords, and derive the correspondence information C0.

Furthermore, in each of the above embodiments, the information processing apparatus according to the present embodiment is applied to the interpretation WS 3, but the present disclosure is not limited thereto. For example, the information processing apparatus according to the present embodiment may be applied to the medical care WS 4.

Further, in each of the above embodiments, for example, as hardware structures of processing units that execute various kinds of processing, such as the image acquisition unit 21, the document creation unit 22, the keyword extraction unit 23, the specifying unit 24, the display controller 25, the association unit 26, and the image analysis unit 27, various processors shown below can be used. As described above, the various processors include a programmable logic device (PLD) as a processor of which the circuit configuration can be changed after manufacture, such as a field-programmable gate array (FPGA), a dedicated electrical circuit as a processor having a dedicated circuit configuration for executing specific processing such as an application-specific integrated circuit (ASIC), and the like, in addition to the CPU as a general-purpose processor that functions as various processing units by executing software (program).

One processing unit may be configured by one of the various processors, or may be configured by a combination of the same or different types of two or more processors (for example, a combination of a plurality of FPGAs or a combination of the CPU and the FPGA). In addition, a plurality of processing units may be configured by one processor. As an example where a plurality of processing units are configured by one processor, first, there is a form in which one processor is configured by a combination of one or more CPUs and software as typified by a computer, such as a client or a server, and this processor functions as a plurality of processing units. Second, as represented by a system-on-chip (SoC) or the like, there is a form of using a processor for realizing the function of the entire system including a plurality of processing units with one integrated circuit (IC) chip. In this way, various processing units are configured by one or more of the above-described various processors as hardware structures.

Furthermore, as the hardware structure of the various processors, more specifically, an electrical circuit (circuitry) in which circuit elements such as semiconductor elements are combined can be used.

The supplementary notes of the present disclosure will be described below.

### Supplementary Note 1

An information processing apparatus comprising at least one processor,
wherein the processor is configured to:
   extract at least one related keyword related to an image from at least one of the image or a sentence described in a first document related to the image;
   refer to correspondence information in which a plurality of second documents of a different type from the first document are associated with at least one keyword included in each of the second documents, and specify at least one second document associated with a keyword that matches or is similar to the related keyword; and
   provide a notification of the specified document.

### Supplementary Note 2

The information processing apparatus according to Supplementary Note 1,
wherein the processor is configured to:
   extract the related keyword from both the image and the sentence described in the first document; and
   specify, in a case in which a related keyword common to the image and the sentence described in the first document is extracted, the second document associated with a keyword that matches or is similar to the common related keyword.

### Supplementary Note 3

The information processing apparatus according to Supplementary Note 1,
wherein the processor is configured to:
   extract the related keyword from both the image and the sentence described in the first document; and
   provide, in a case in which a related keyword common to the image and the sentence described in the first document is extracted, a notification of the second document associated with a keyword that matches or is similar to the common related keyword with priority over the second document associated with a keyword that matches or is similar to a related keyword other than the common related keyword.

### Supplementary Note 4

The information processing apparatus according to any one of Supplementary Notes 1 to 3, wherein the processor is configured to preferentially provide a notification of the second document associated with a keyword that has a high relevance to the related keyword.

### Supplementary Note 5

The information processing apparatus according to any one of Supplementary Notes 1 to 4, wherein the keywords are classified for each of properties of the keywords.

### Supplementary Note 6

The information processing apparatus according to any one of Supplementary Notes 1 to 5,
wherein the processor is configured to:
   extract a keyword from the second document; and
   derive the correspondence information by associating the extracted keyword with the second document.

### Supplementary Note 7

The information processing apparatus according to any one of Supplementary Notes 1 to 6, wherein the processor is configured to provide the notification of the specified document by displaying a list of the specified second documents.

### Supplementary Note 8

The information processing apparatus according to Supplementary Note 7, wherein the processor is configured to display the list such that at least a part of the list overlaps a region in which the first document is displayed.

### Supplementary Note 9

An information processing method executed by a computer, the information processing method comprising:
extracting at least one related keyword related to an image from at least one of the image or a sentence described in a first document related to the image;
referring to correspondence information in which a plurality of second documents of a different type from the first document are associated with at least one keyword included in each of the second documents, and specifying at least one second document associated with a keyword that matches or is similar to the related keyword; and
providing a notification of the specified document.

### Supplementary Note 10

An information processing program causing a computer to execute:
extracting at least one related keyword related to an image from at least one of the image or a sentence described in a first document related to the image;
referring to correspondence information in which a plurality of second documents of a different type from the first document are associated with at least one keyword included in each of the second documents, and specifying at least one second document associated with a keyword that matches or is similar to the related keyword; and
providing a notification of the specified document.

What is claimed is:

1. An information processing apparatus comprising at least one processor,
wherein the processor is configured to:
extract at least one related keyword related to an image from at least one of the image or a sentence described in a first document related to the image;
refer to correspondence information in which a plurality of second documents of a different type from the first document are associated with at least one keyword included in each of the second documents, and specify at least one second document associated with a keyword that matches or is similar to the related keyword; and
provide a notification of the specified document.

2. The information processing apparatus according to claim 1,
wherein the processor is configured to:
extract the related keyword from both the image and the sentence described in the first document; and
specify, in a case in which a related keyword common to the image and the sentence described in the first document is extracted, the second document associated with a keyword that matches or is similar to the common related keyword.

3. The information processing apparatus according to claim 1,
wherein the processor is configured to:
extract the related keyword from both the image and the sentence described in the first document; and
provide, in a case in which a related keyword common to the image and the sentence described in the first document is extracted, a notification of the second document associated with a keyword that matches or is similar to the common related keyword with priority over the second document associated with a keyword that matches or is similar to a related keyword other than the common related keyword.

4. The information processing apparatus according to claim 1,
wherein the processor is configured to preferentially provide a notification of the second document associated with a keyword that has a high relevance to the related keyword.

5. The information processing apparatus according to claim 1,
wherein the keywords are classified for each of properties of the keywords.

6. The information processing apparatus according to claim 1,
wherein the processor is configured to:
extract a keyword from the second document; and
derive the correspondence information by associating the extracted keyword with the second document.

7. The information processing apparatus according to claim 1,
wherein the processor is configured to provide the notification of the specified document by displaying a list of the specified second documents.

8. The information processing apparatus according to claim 7,
wherein the processor is configured to display the list such that at least a part of the list overlaps a region in which the first document is displayed.

9. An information processing method executed by a computer, the information processing method comprising:
extracting at least one related keyword related to an image from at least one of the image or a sentence described in a first document related to the image;
referring to correspondence information in which a plurality of second documents of a different type from the first document are associated with at least one keyword included in each of the second documents, and specifying at least one second document associated with a keyword that matches or is similar to the related keyword; and
providing a notification of the specified document.

10. A non-transitory computer-readable storage medium that stores an information processing program causing a computer to execute:
extracting at least one related keyword related to an image from at least one of the image or a sentence described in a first document related to the image;
referring to correspondence information in which a plurality of second documents of a different type from the first document are associated with at least one keyword included in each of the second documents, and specifying at least one second document associated with a keyword that matches or is similar to the related keyword; and
providing a notification of the specified document.
